(19) United States
(12) Patent Application Publication
(10) Pub. No.: US 2007/0261477 A1
(43) Pub. Date: Nov. 15, 2007

(54) Apparatus for Detecting Leakage of Liquid in Tank

(76) Inventors: Atsushi Koike, Saitama (JP); Tsutomu Makino, Saitama (JP)

Correspondence Address: Ronald R Santucci;c/o Frommer Lawrence & Haug LLP, 745 Fifth Avenue, New York, NY, 10151, US

(21) Appl. No.: 11/659,241

(22) PCT Filed: Jul. 29, 2005
(86) PCT No.: PCT/JP05/13917

§ 371 Date: Feb. 2, 2007

(30) Foreign Application Priority Data
Aug. 6, 2004 (JP) 2004-230788

(51) Int. Cl. G01M 3/26

(52) U.S. Cl. 73/49.2

(57) ABSTRACT

A apparatus for detecting leakage of a liquid in a tank, where erroneous detection is suppressed and which is capable of fine and accurate display and warning that depend on the degree of increase and decrease in the quantity of the liquid. The apparatus performs a first liquid quantity variation detection for detecting liquid quantity variation based on a flow rate corresponding value that is calculated using an output of a flow rate sensor section and also performs a second liquid quantity variation detection for detecting liquid quantity variation based on a time variation rate of a liquid level that is measured by the pressure sensor. When it is determined in a first stage (S1) that an absolute value of the liquid quantity variation obtained by the second liquid quantity variation detection does not exceed a first predetermined value (C1), then, in a second stage (S2) after an intermediate stage (Si), an average absolute value of liquid quantity variation is obtained from liquid quantity variations that are obtained by the second liquid quantity variation detection of plural times. After that, when it is determined that the average absolute value exceeds a second predetermined value (C2) that is smaller than the first predetermined value, an average value of liquid quantity variation relating to the average absolute value of liquid quantity variation is outputted as a liquid quantity variation, and when it is determined that the average absolute value does not exceed the second predetermined value (c2), the liquid quantity variation obtained by the first liquid quantity variation detection is outputted.

### TECHNICAL FIELD

The present invention relates to an apparatus for detecting leakage of liquid in a tank end, more particularly to, an apparatus for detecting leakage or leak of liquid from a tank by converting it into a flow based on the level variation of liquid in a tank.

### BACKGROUND ART

Fuel oil or various liquid chemicals are stored in a tank. In recent years, for example, a centralized oiling system for collective housing has been proposed. In this system, kerosene is supplied to the respective homes from a centralized kerosene tank through tubes.

The tank may suffer some cracks die to time degradation. In this case, liquid in the tank leaks from the tank. It is very important to detect such leakage as soon as possible and cope with it adequately for preventing explosion and fire hazard, ambient pollution, or generation of poisonous gas.

As an apparatus for detecting leakage of liquid in a tank in the shortest possible time, JF-A-2003-185522 (Patent Document 1) has proposed a configuration that includes a measuring pipe or measuring tube into which liquid in a tank is introduced and a measuring slim-tube provided below the measuring tube and measures the flow rate of liquid inside the measuring slim-tube using a sensor section additionally provided to the measuring slim-tube to detect a minute variation of the liquid surface in the tank, i.e., a liquid level variation.

In this liquid leakage detection apparatus, an indirectly heated flowmeter is used as a sensor additionally provided to the measuring slim-tube. In this flowmeter, an electric current is applied to a heating element to generate heat, and a part of the heating value is allowed to be absorbed by the liquid. Then, the heat absorption value of the liquid varies in accordance with the liquid flow rate. This characteristic is used to detect influence of the heat absorption based on a variation in an electrical characteristic value such as a resistance value represented by a temperature variation of a temperature-sensitive element.

However, in the indirectly heated flowmeter used in the liquid leakage detection apparatus disclosed in the above Patent Document 1, a variation in an electric circuit output level with respect to a variation in a liquid flow rate becomes small in the region where the flow rate value is as infinitesimal as, e.g., 1 milliliter/h or less, so that an error in the flow rate measurement valve tends to increase. Thus, there is a limit to an improvement in leakage detection accuracy.
Patent Document 1: JP-A-2003-185522

### DISCLOSURE OF INVENTION

### Problems to be Solved by the Invention

In the meantime, the level of a liquid in a tank varies due to various causes. For example, such causes include inflow of an external liquid into the tank through the cracks of the tank, normal replenishment of a liquid into the tank from the outside, or normal supply (drawing out of a liquid from the tank to the outside, in addition to the leakage as described above due to the cracks of the tank.

Furthermore, even if there is no increase or decrease of the liquid in the tank, there may temporarily occur partial variations (ruffling) of the liquid level in the tank due to external forces applied to the tank. In such a case, if the increase or decrease of the liquid in the tank is detected based on an instantaneous flow rate at the position of the flowmeter, it will be misjudged that there is leakage of the liquid from the tank or inflow of a liquid into the tank.

Furthermore, the electric signals which are output from the flowmeter are input to the control unit for detecting leakage. However, electromagnetic noises may break into this signal transmission route. These noises are usually ones that last very short time and that are generated, for example, by thunders or the like. In this case, even if the signals which are output from the flowmeter are ones indicating no leakage or no inflow of a liquid, the signals which are input to the control unit will be similar to ones indicating leakage or inflow of a liquid. Also in this case, a misjudgment as described above will be made.

In view of the above, it is desirable to comprehend the variations (increase or decrease) of the quantity of a liquid in the tank accurately and to perform fine and accurate display and warning depending on the degree of the variations.

Thus, a first object of the present invention is to provide an apparatus for detecting leakage of a liquid in a tank capable of suppressing erroneous detection when detecting leakage by using a flowmeter.

Further, a second object of the present invention is to provide an apparatus for detecting leakage of a liquid in a tank capable of fine and accurate display and warning depending on the increase or decrease in the quantity of the liquid in the tank.

### Means for Solving the Problems

To achieve the above objects, according to the present invention, there is provided an apparatus for detecting leakage of a liquid in a tank, comprising:

a measuring slim-tube into/from which the liquid in the tank is introduced or discharged through the lower end thereof;

a measuring tube connected to the upper end of the measuring slim-tube and having a sectional area larger than that of the measuring slim-tube;

a flow rate sensor section that is additionally provided to the measuring slim-tube and measures the flow rate of the liquid in the measuring slim-tube;

a pressure sensor for measuring the level of the liquid; and

a leakage detection control section connected to the flow rate sensor section and the pressure sensor, wherein the leakage detection control section performs a first liquid quantity variation detection for detecting in a first cycle a liquid quantity variation in the tank based on a low rate corresponding value which corresponds to the flow rate of the liquid calculated by using the outputs of the flow rate sensor section and a second liquid quantity variation detection for detecting in a second cycle a liquid quantity variation in the tank based on a time variation rate of a liquid level that is measured by the pressure sensor, and determines in a first step whether an absolute value of the liquid quantity variation obtained by the second liquid quantity variation detection exceeds a first predetermined value or not,

wherein when it is determined that the absolute value of liquid quantity variation does not exceed the first predetermined value, the leakage detection control section obtains in a second step an average absolute value as absolute value of an average value of liquid quantity variations of the liquid obtained by the second liquid quantity variation detection of plural times, and determines whether the average absolute value exceeds a second predetermined value smaller than the first predetermined value, and

wherein when it is determined that the average absolute value exceeds the second predetermined value, the leakage detection control section outputs the average value of the liquid quantity variations relating to the average absolute value as a liquid quantity variation, aid on the contrary, when it is determined that the average absolute value does not exceed the second predetermined value, he leakage detection control section outputs the liquid quantity variation obtained by the first liquid quantity variation detection.

In an aspect of the present invention, when the absolute value of the liquid quantity variation obtained by the first liquid quantity variation detection does not exceed a third predetermined value smaller than the second predetermined value, the leakage detection control section judges that there is no variation of the liquid quantity and outputs the result of such judgment in place of or together with the liquid quantity variation.

In an aspect of the present invention, when it is determined that the average absolute value does not exceed the second predetermined value, and when the sign of the liquid quantity variation obtained by the first liquid quantity variation detection is minus on the one hand, the leakage detection control section judges that there is leakage of liquid, and when the sign is plus on the other hand, the section judges that there is inflow of liquid, outputting the result of such judgment in place of or together with the liquid quantity variation.

In an aspect of the present invention, when it is determined that the average absolute value exceeds the second predetermined value, the leakage detection control section judges that liquid quantity management is required due to leakage or inflow of liquid, outputting the result of such judgment together with the liquid quantity variation.

In an aspect of the present invention, when it is determined in the first stop that the absolute value of the liquid quantity variation exceeds the first predetermined value, the leakage detection control section judges that there is liquid replenishment from the outside into the tank or liquid supply from the tank to the outside, outputting the result of such judgment together with the liquid quantity variation. In an aspect of the present invention, when it is determined in the first step that the absolute value of the liquid quantity variation exceeds the first predetermined value, and when the sign of the liquid quantity variation obtained by the second liquid quantity variation detection is minus on the one hand, the leakage detection control section judges that there is the liquid supply, and when the sign is plus on the other hand, the section judges that there is the liquid replenishment, outputting the result of such judgment together with the liquid quantity variation.

In an aspect of the present invention, the leakage detection control section proceeds to the second step after a predetermined period of time has passed since it was finally determined in the first step that the absolute value of the liquid quantity variation exceeds the first predetermined value, and outputs a signal indicating that liquid surface stabilization is being waited for during the predetermined period of time. In an aspect of the present invention, the leakage detection control section stops the first liquid quantity variation detection during the predetermined period of time. In an aspect of the present invention, the leakage detection control section stops the operation of the flow rate sensor section during the predetermined period of time.

In an aspect of the present invention, when it is determined that the average absolute value does not exceed the second predetermined value, the leakage detection control section outputs as the liquid quantity variation to be output an average liquid quantity variation in the first liquid quantity variation detection during a period of time required for the second liquid quantity variation detection of plural times obtaining the average value of the liquid quantity variations.

In an aspect of the present invention, the flow rate sensor section includes a first temperature sensor, a heater and a second temperature sensor sequentially arranged along the measuring slim-tube, and the leakage detection control section has a voltage generating circuit for applying voltage to the heater and a leakage detecting circuit connected to the first and second temperature sensors and generating an output corresponding to a difference between temperatures detected by these temperature sensors. In an aspect of the present invention, each of the first and second temperature sensors has a heat transfer member brought into contact with the outer surface of the measuring slim-tube and a temperature sensitive element coupled to the heat transfer member, and the heater has a heat transfer member brought into contact with the outer surface of the measuring slim-tube and a heating element coupled to the heat transfer member.

In an aspect of the present invention, the voltage generating circuit is a pulse voltage generating circuit which applies a single pulse voltage to the heater, and the leakage detection control section calculates a flow rate corresponding value which corresponds to the flow rate of the liquid by integrating a difference between an output of the leakage detecting circuit and its initial value in response to the application of the single pulse voltage to the heater to thereby detect liquid quantity variation of the liquid in the tank based on the calculated value. In an aspect of the present invention, the single pulse voltage has a pulse width of 2 to 10 seconds, and the flow rate corresponding value is obtained by integrating the output of the leakage detecting circuit for 20 to 150 seconds. In an aspect of the present invention, the pulse voltage generating circuit applies the single pulse voltage to the heater at a time interval of 40 seconds to 5 minutes which is longer than the integration time period during which the difference between the output of the leakage detecting circuit and its initial value is integrated.

In an aspect of the present invention, the voltage generating circuit is a constant voltage generating circuit which applies a constant voltage to the heater.

In an aspect of the present invention, the pressure sensor is arranged in the vicinity of the lower end of the measuring slim-tube.

### EFFECT OF THE INVENTION

According to the present inventor, when it is determined in the first step that the absolute value of the liquid quantity variation does not exceed the first predetermined value, the second liquid quantity detection is performed in the second step in which the average absolute value of liquid quantity variations is obtained by time-averaging partial and rapid variations of the liquid level even if they have occurred due to temporary or instantaneous causes such as oscillating liquid in the tank or the like. When it is, determined that this average absolute value of liquid quantity variations exceeds the second predetermined value, the average value of liquid quantity variations relating to the average absolute value of liquid quantity variations is output as a liquid quantity variation, and when it is determined that this average absolute value of liquid quantity variations does not exceed the second predetermined value, the liquid quantity variation obtained by the first liquid quantity variation detection is output. Therefore, erroneous detection is suppressed in leakage detections using a flowmeter. Further, according to the present invention, there can be performed fine and accurate display and warning depending on the degree of increase or decrease in the quantity of the liquid in the tank.

### BRIEF DESCRIPTION OF THE DRAWINGS

FIG. 1 is a partially broken perspective view for explaining an embodiment of an apparatus for detecting leakage of liquid in a tank according to the present invention;

FIG. 2 is a partially omitted cross-sectional view of the apparatus for detecting leakage of FIG. 1;

FIG. 3 is an enlarged perspective view showing a part where the first temperature sensor, heater, and second temperature sensor are attached to a measuring slim-tube;

FIG. 4 is a, cross-sectional view of FIG. 3;

FIG. 5 is a view showing a circuit configuration of the flow rate sensor section, pressure sensor and leakage detection control section;

FIG. 6 is a timing chart showing a relationship between a voltage Q to be applied to the thin-film heating element and a voltage output S of a leakage detecting circuit;

FIG. 7 is a view showing a concrete example of a relationship between the voltage Q applied to the thin-film heating element and voltage output S of the leakage detecting circuit;

FIG. 8 is a view showing a concrete example of a relationship between a liquid level variation rate and an integrated value δ(S₀-S)dt;

FIG. 9 is a view showing a concrete example of a relationship between a liquid level variation speed and a variation rate P′ with respect to time of an output corresponding to liquid level;

FIG. 10 is a flow chart showing the detection of quantity variation of a liquid in the tank and the output of the result thereof;

FIG. 11 is a view showing an example of a relationship between a liquid quantity variation ΔLV2 and an average value Av(ΔLV2) of the liquid quantity variation ΔLV2;

FIG. 12 is a view showing variations of the liquid level and liquid level variation rate in the case where the liquid quantity in the tank varies due to various causes, and further showing contents of the results of judgments corresponding to these situations; and

FIG. 13 is a view showing an example of a calibration curve for conversion of a voltage output S of the leakage detecting circuit,

wherein reference numeral 1 denotes a tank, 2 a top panel, 3 a side panel, 4 a bottom panel, 5 a measurement port, 6 a liquid inlet, 7 a liquid supply port, L a liquid, LS a liquid surface, 11 an apparatus for detecting leakage, 12 a liquid inlet/outlet section, 12a a filter, 12b a filter cover, 13 a flow rate measurement section, 13a a sensor holder, 13b a measuring slim-tube, 133 a first temperature sensor, 134 a second temperature sensor, 135 a heater, 137 a pressure sensor, 14 a liquid pool section, G a space, 15 a circuit container, 15a a leakage detection control section, 16 a cap, 16a an air path, 17 a sheath pipe, Pg a guide pipe, 18 a wiring, 181 a heat transfer member, 182 a thin-film heating element, 182′ a wiring, 23 a sealing member, 24 a wiring board, 60,61 a thin-film temperature sensitive element, 62 63 a resistor, 65 a differential amplifier, 66 an A/D converter, 67 a voltage generating circuit, 68 a CPU, 69 a clock, 70 a memory, 71 a leakage detecting circuit, and 73 an A/D converter.

### BEST MODE FOR CARRYING OUT THE INVENTION

Embodiment of the present invention will be described below with reference to the accompanying drawings.

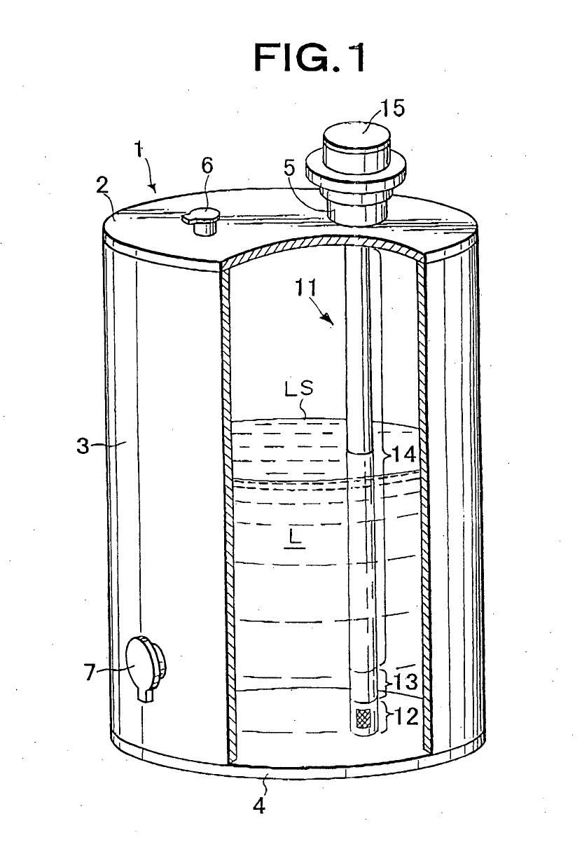

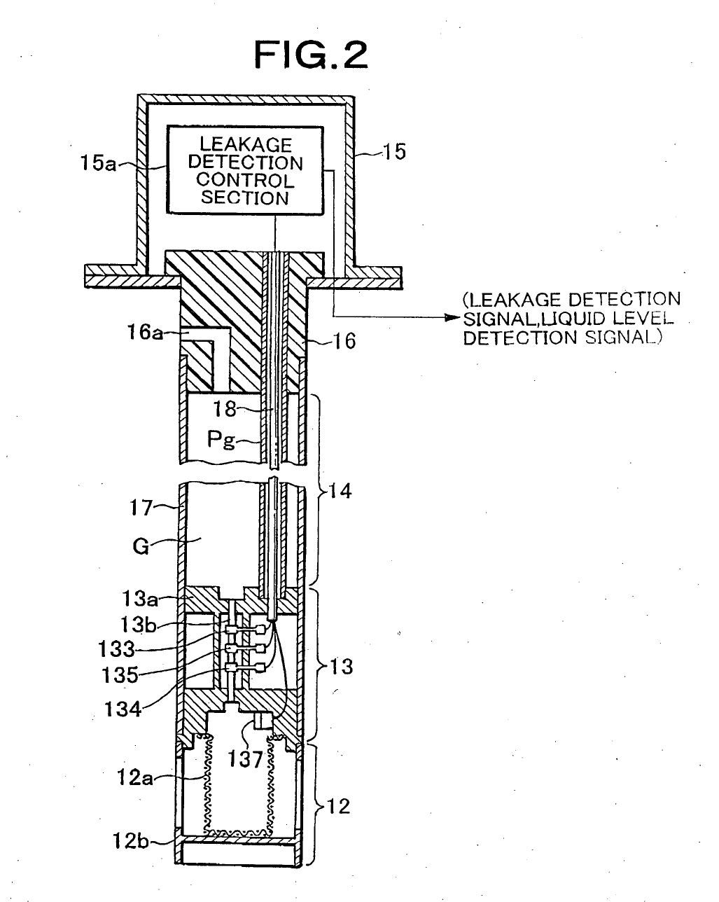

FIG. 1 is a partially broken view for explaining an embodiment of an apparatus for detecting leakage of liquid in a tank according to the present invention, and FIG. 2 is a partially omitted cross-sectional view of the apparatus for detecting leakage according to the present embodiment.

A tank 1 has a top panel 2 in which a measurement port 5 and a liquid inlet 6 used when liquid is introduced into the tank are formed, a side panel 3,in which a liquid supply port 7 used when liquid in the tank is supplied to the outside is formed, and a bottom panel 4. As shown in FIG. 1, liquid L (flammable liquid such as gasoline, diesel oil, kerosene, or the like) is contained in the tank 1. IS denotes a liquid surface. A portion of an apparatus for detecting leakage 11 is inserted into the tank 1 through the measurement port 5 formed in the top panel 2 of the tank 1, and the apparatus for detecting leakage 11 is disposed in the vertical direction as a whole. The apparatus for detecting leakage 11 includes a liquid inlet/outlet section 12, a flow rate measurement section 13, a liquid pool section 14, a cap 16, and a circuit container 15. The liquid inlet/outlet section 12, flow rate measurement section 13, and liquid pool section 14 are located inside the tank 1. The liquid surface LS is positioned within the height range of the liquid pool section 14. The flow rate measurement section 13 and liquid pool section 14 include a sheath pipe 17 extending over them in the vertical direction.

As shown in FIG. 2, a sensor holder 13a is disposed in the sheath pipe 17 in the flow rate measurement section 13. A measuring slim-tube 13b extending in the vertical direction is fixedly held by the sensor holder 13a. A first temperature sensor 133, a heater 135, and a second temperature sensor 134 are disposed in the measuring slim-tube 13b from above in the order mentioned and attached thereto. The heater 135 is equally spaced apart from the first and second temperature sensors 133 and 134. The outside of the sensor holder 13a is covered with the sheath pipe 17, thereby protecting tho first temperature sensor 133, heater 135, and second temperature sensor 134 from being corroded by the liquid L. The measuring slim-tube 13b serves as a liquid passage between the liquid pool section 14 and liquid inlet/outlet section 12. The first temperature sensor 133, heater 135, and second temperature sensor 134 constitute a sensor section or measuring the flow rate of liquid in the measuring slim-tube 13b.

A pressure sensor 137 is attached to the sensor holder 13a at the portion near the lower end of the measuring slim-tube 13b in the flow rate measurement section 13. The pressure sensor 137, which is used for measuring the level of liquid L in the tank, can be a piezoelectric element or condenser type pressure detecting element. The pressure sensor 137 outputs en electrical signal corresponding to the liquid level, e.g., a voltage signal.

In the liquid inlet/outlet section 12, as shown in FIG. 2, a filter cover 12b fixes a filter 12a to the lower portion of the sensor holder 13a. The filter 12a was a function of filtrating the liquid in the tank so as to introduce it, without foreign substances such as sludge floated or deposited in the liquid in the tank, into the liquid pool section 14 through the measuring slim-tube 13b. An opening is formed in the side wall of the filter cover 12b, and the liquid L in the tank 1 is introduced into the measuring slim-tube 13b through the filter 12a of the liquid inlet/outlet section 12.

The liquid pool section 14 is located above the flow rate measurement section 13 and has a space S surrounded by the sheath pipe 17. Liquid introduced through the measuring slim-tube 13b is pooled in the space G. The cap 16 is fixed to the upper portion of the sheath pipe 17 and has an air path 16a for communicating the space in the liquid pool section 14 with space in the tank 1 outside the apparatus for detecting leakage of liquid. The circuit container 15, which is attached to the cap 16, contains a leakage detection control, section 15a. A guide pipe Pg extends in the sheath pipe 17 so as to connect the upper portion of the sensor holder 13a and cap 16 and, inside the guide pipe Pg, a wiring 18 extends so as to connect the first temperature sensor 133, heater 135, second temperature sensor 134 and pressure sensor 137 with the leakage detection control section 15a.

The sheath pipe 17 in the liquid pool section 14 serves as a measuring tube of the present invention. The sectional area of the measuring slim-tube 13b is set much smaller (e.g., 1/50 or more, 1/100 or less, or 1/300 or less) than that of the sheath pipe 17 (excluding the sectional area of the guide pipe Pg). This configuration allows liquid flow through the measuring slim-tube 13b to be measurable even in the case of a slight liquid level variation accompanied by a slight liquid leakage.

It is preferable that the sheath pipe 17, sensor holder 13a, filter cover 12b, cap 16, and guide pipe Pg be made of metal having a heat expansion coefficient approximate to that of a material constituting the tank 1 and be made of the same metal as the material of the tank 1, such as casting iron or stainless steel.

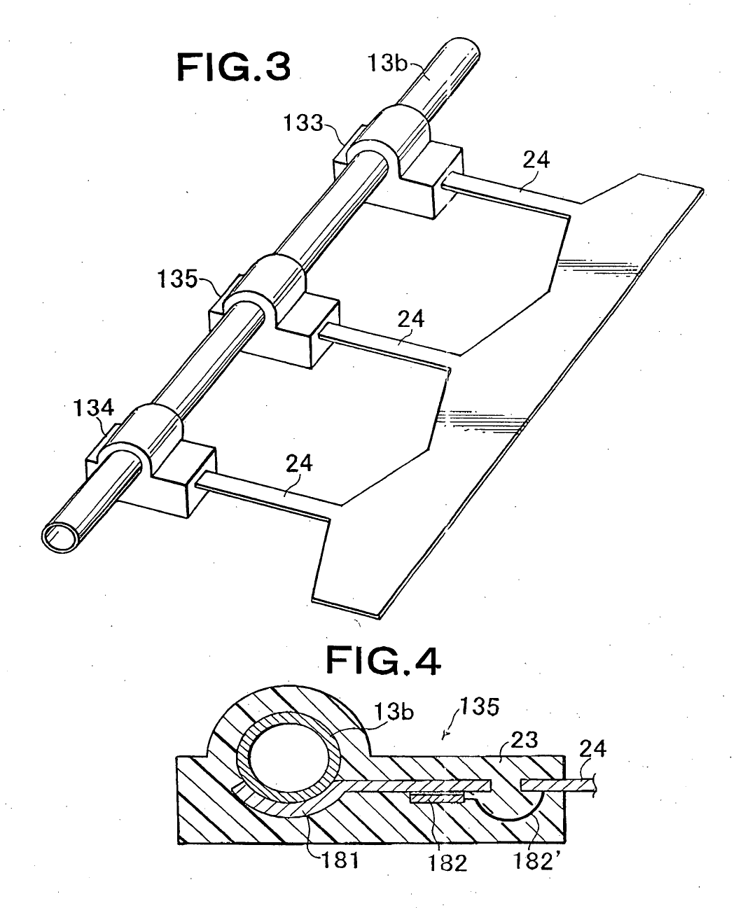

FIG. 3 is an enlarged perspective view showing a part where the first temperature sensor 133, heater 135, and second temperature sensor 134 are attached to the measuring slim-tube, and FIG. 4 is a cross-sectional view of FIG. 3. The heater 135 has a heat transfer member 181 brought into contact with the outer surface of the measuring slim-tube 13b and a thin-film heating element 182 stacked on the heat transfer member 181 through a dielectric thin-film. The thin-film heating element 182 is formed in a predetermined pattern. A wiring 182′ is connected to the electrode of the thin-film heating element 182 for current application to the thin-film heating element 182. The heat transfer member 181 is made of, e.g., metal or alloyed metal having a thickness of about 0.2 mm and width of 2 mm. The wiring 182′ is connected to a wiring (not shown) formed on a wiring board 24 such as a flexible wiring board. The latter wiring is connected to the wiring 18 in the guide pipe Pg. The heat transfer member 181, thin-film heating element 182, and wiring 182′ are sealed with a plastic sealing member together with a part of the wiring board 24 and a part of the measuring slim-tube 13b. The first and second temperature sensors 133 and 134 have substantially the same configuration as that of the heater 135. Only a different point is that a thin-film temperature-sensitive element is used in place of the thin-film heating element in the first and second temperature sensors 133 and 134.

The apparatus for detecting leakage 11 having the configuration described above is attached to the measurement port 5 of the tank 1. Then, the liquid surface LS of the liquid L in the tank is positioned in the height range of the liquid pool section 14, as described above. Accordingly, the pressure sensor 137 is immersed in the liquid L in the tank filtrated by the filter 12a of the liquid inlet/outlet section 12. The liquid L in the tank rises through the measuring slim-tube 13b of the flow rate measurement section 13, introduced into the space G of the liquid pool section 14, with the result that the surface of the liquid in the liquid pool section 14 reaches the same height as the liquid surface LS of the liquid in the tank outside the apparatus for detecting leakage. When the liquid surface LS varies, the surface of the liquid in the liquid pool section 14 correspondingly varies to cause liquid flow in the measuring slim-tube 13b in association with this liquid surface variation, i.e., liquid level variation.

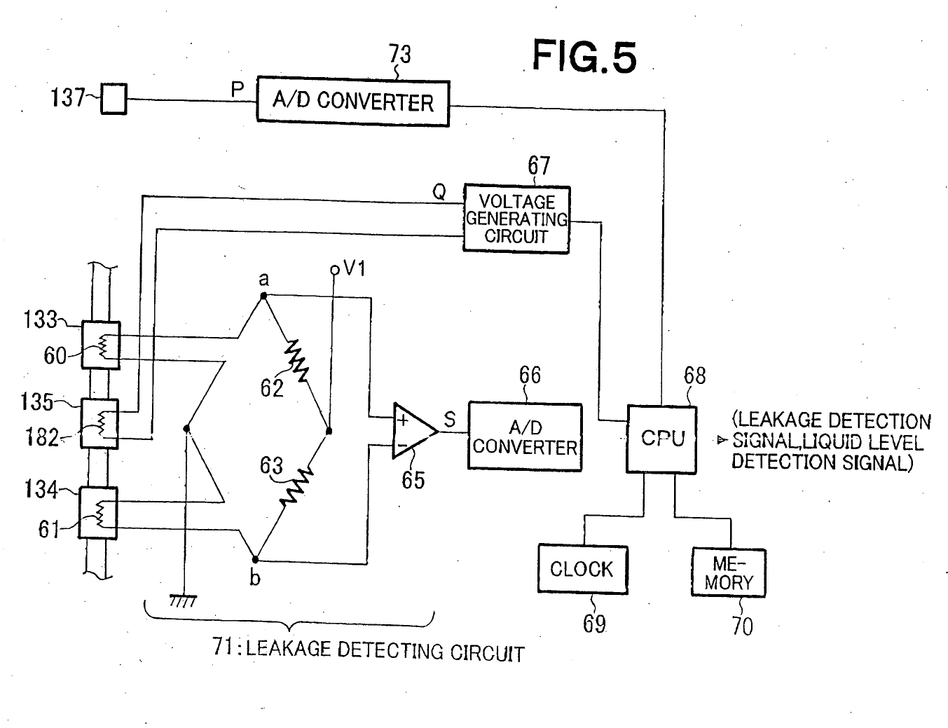

FIG. 5 is a view showing a circuit configuration of the sensor section, pressure sensor and leakage detection control section. As a power source for the circuits, a not-shown battery disposed in the circuit container 15 can be used.

The thin-film heating element 182 of the heater 135 is connected to a voltage generating circuit 67. In the present embodiment, a pulse voltage generating circuit is used as the voltage generating circuit 67. A single pulse voltage is timely applied from the pulse voltage generating circuit to the thin-film heating element 182. Thin-film temperature sensitive elements 60 and 61 respectively constituting the first and second temperature sensors 133 and 134 are connected to a leak detecting circuit 71. That is, the thin-film temperature sensitive elements 60 and 61 constitute a bridge circuit together with resistors 62 and 63. A supply voltage V1 is supplied to the bridge circuit, and a voltage output signal corresponding to a potential difference between points a and b can be obtained by a differential amplifier 65. The output of the leak detecting circuit 71, which corresponds to a difference in temperature sensed by the thin-film temperature sensitive elements 60 and 61 of the temperature sensors 133 and 134, is input to a CPU 68 through al A/D converter 66. The pulse voltage generating circuit 67 operates under the control of the CPU 68. The output of the pressure sensor 137 is input to the CPU 68 through an A/D converter 13 A clock 69 and a memory 70 are connected to the CPU.

Operation of detecting the liquid quantity variation in tank including leakage detection operation, i.e., operation of the CPU 68 in the present embodiment will be described below. In the following description, the liquid quantity variation, i.e., increase or decrease in quantity of liquid in the tank occurring on the basis of various cause is represented by leakage. Accordingly, for example, the first liquid quantity variation detection and second liquid quantity variation detection are merely called as a first leakage detection and second leakage detection, respectively.

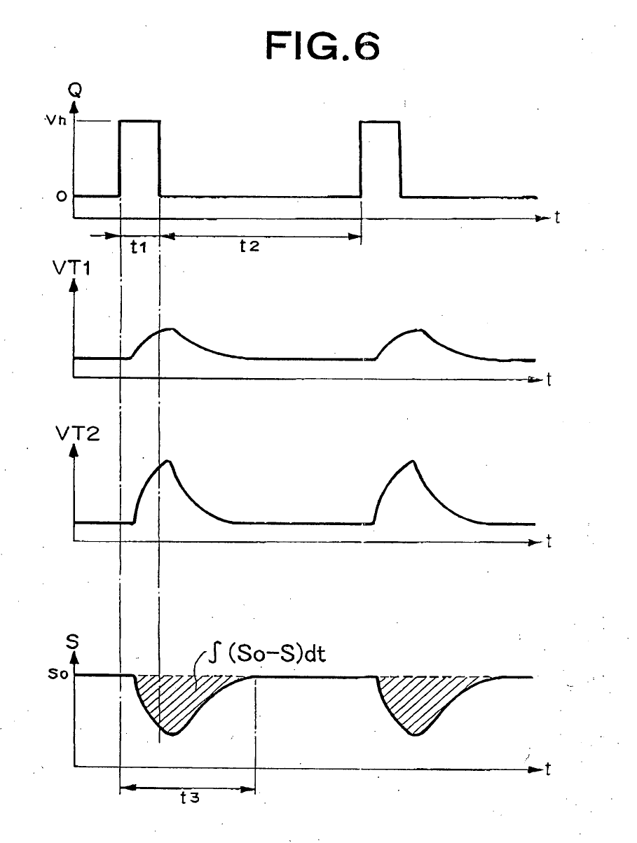

FIG. 6 is a timing chart showing a relationship between an voltage Q to be applied from the pulse voltage generating circuit 67 to the thin-film heating element 182 and a voltage output S of the leak detecting circuit 71. A single pulse voltage having a time width t1 is applied from the CPU 68 at a predetermined time internal t2 according to the clock 69. In this case, for example, the pulse width t1 corresponds to 2 to 10 seconds, and a pulse height Vh corresponds to 1.5 to 4 V. The above voltage application causes heat in the thin-film heating element 182. The heat then heats the measuring slim-tube 13b and liquid inside the measuring slim-tube 13b and, thereby, is transmitted to the surrounding area. Influence of the heat reaches the thin-film temperature sensitive elements 60 and 61 to thereby vary the temperature of the thin-film temperature sensitive elements. Assuming that the flow rate of liquid in the measuring slim-tube 13b is 0, the temperatures in the two temperature sensitive elements 60 and 61 equally vary, if contribution of natural convection to the heat transfer is ignored. However, in the case where the surface of liquid in the tank is lowered due to, e.g., leakage of liquid in the tank, the liquid is moved downward from the liquid pool section 14 to the measuring slim-tube 13b and is then withdrawn into the tank outside the apparatus for detecting leakage of liquid through the liquid inlet/outlet section 12. That is, the liquid in the measuring slim-tube 13b flows downward. It follows that the heat from the thin-film heating element 182 is transferred more to the thin-film temperature sensitive element 61 of the lower side temperature sensor 134 than to the thin-film temperature sensitive element 60 of the upper side temperature sensor 133. As a result, a difference occurs between the temperatures that the two thin film temperature sensitive elements detect, making resistance variation of the thin-film temperature sensitive elements different from each other. FIG. 6 shows a variation in a voltage VT1 to be applied to the thin-film temperature sensitive element 60 of the temperature sensor 133 and a variation in a voltage VT2 to be applied to the thin-film temperature sensitive element 61 of the temperature sensor 134. As a result, the output of the differential amplifier, i.e., the voltage output S of the leak detecting circuit 71 varies as shown in FIG. 6.

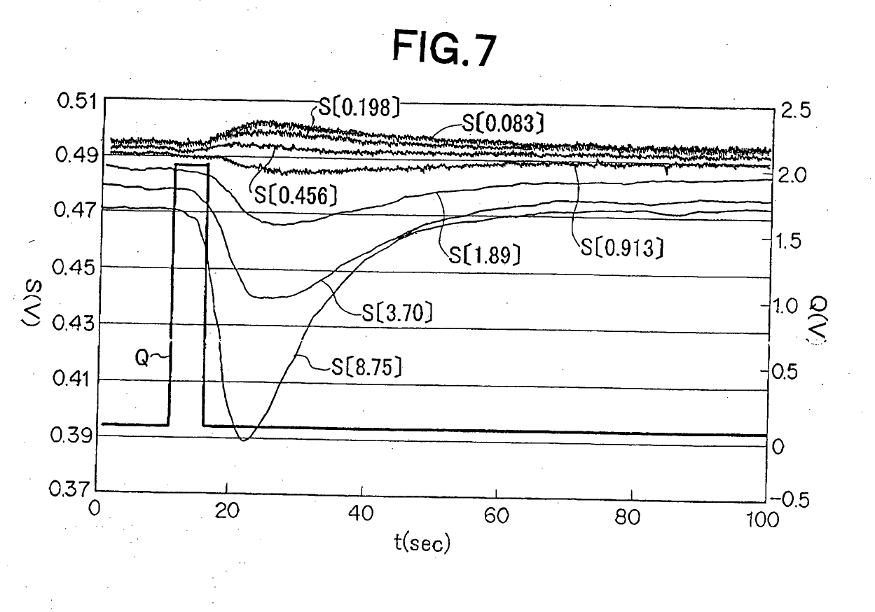

FIG. 7 shows a concrete example of a relationship between the voltage Q applied from the pulse voltage generating circuit 67 to the thin-film heating element 182 and voltage output S of the leak detecting circuit 1. In this example, a single pulse voltage has a pulse height Vh corresponding to 2 V and a pulse width t1 corresponding to 5 seconds, and a liquid level variation rate F [mm/h] is varied to obtain a voltage output S [F].

When the pulse voltage generating circuit 67 starts applying the single pulse voltage to the thin-film heating element 182 of the heater 135, the CPU 68 integrates a difference (S₀-S) between the voltage Output S of the leakage detecting circuit and its initial values (i.e., value obtained at the single pulse voltage application start time) S₀ for a predetermined time period t3 after the start of the single pulse voltage application. The integrated value δ(S₀-S)dt corresponds to the area marked with diagonal or oblique lines in FIG. 6 and to a value equivalent to the flow rate of liquid in the measuring slim-tube 13b. The predetermined time period t3 corresponds to, e.g., 20 to 150 seconds.

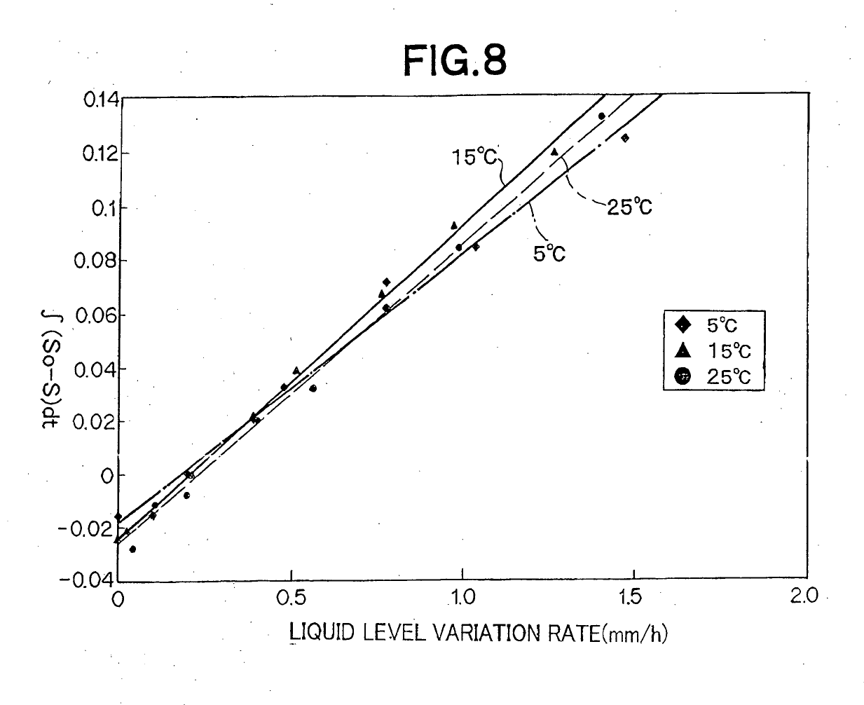

FIG. 8 shows a concrete example of a relationship between the liquid level variation rate corresponding to the liquid flow rate F in the measuring slim-tube 13b and the above integrated value δ(S₀-S)dt. In this example, the predetermines time period t3 for obtaining the integrated value is set to 30 seconds, and relations are obtained for three different temperatures. It can be seen from FIG. 8 that a favorable linear relationship exists between the liquid level variation rate and the integrated value δ(S₀-S)dt in the region where the liquid level variation rate is set to 1.5 mm/h or less, irrespective of the set temperature. While a favorable linear relationship is represented in the region where the liquid level variation rate is set to 1.5 mm/h or less, it is possible to obtain a favorable linear relationship in the region where the liquid level variation rate is set to 20 mm/h or less by appropriately setting a ratio of the sectional area of the measuring slim-tube relative to that of the measuring tube or the length of the measuring slim-tube.

Such a typical relationship between the integrated value δ(S₀-S)dt and the liquid level variation rate can be previously stored in the memory 70. Therefore, it is possible to obtain leakage of liquid in the tank as a liquid level variation rate by referring to the stored data in the memory 70 according to the integrated value δ(S₀-S)dt corresponding to a value equivalent to the flow rate calculated by using the output of the leak detecting circuit 71 to perform conversion. However, in the case where a liquid level variation rate smaller than a given value (e.g., 0.01 mm/h) is obtained, it is possible to determine that the variation is not due to leakage but to a measurement error.

The first leakage detection operation as described above is repeatedly performed at an appropriate time interval t2, i.e., in a first cycle t1+t2. The time interval t2 corresponds to, e.g., 40 seconds to 5 minutes (t2 reeds to be larger than integration time period t3).

When receiving an output P equivalent to liquid level which is input from the pressure sensor 137 through the A/D converter 73, the CPU 68 can immediately convert it into a liquid level p. While the value of the liquid level p is based on the height of the pressure sensor 137, it is possible to convert the value to the liquid level value with respect to the height of the bottom of the tank by taking into account the vertical position of the measurement port 5 in the tank 1 and the distance from the attachment part of the apparatus for detecting leakage to the measurement port 5 to the pressure sensor 137. A liquid level detection signal indicating results of the liquid level detection is output from the CPU 68.

The CPU 68 stores the value of the liquid level p in the memory 70 at a constant time interval tt, i.e., in a second cycle tt, of, e.g., 2 to 10 seconds, calculates a difference between the current value and previous value for each storage operation, and stores the difference in the memory 70 as a value of liquid level variation rate p′ with respect to time.

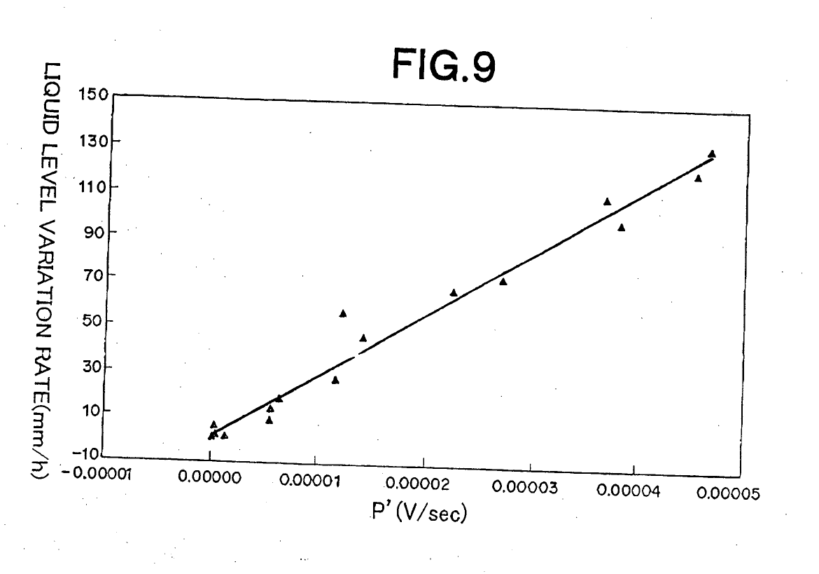

FIG. 9 shows a concrete example of a relationship between the liquid level variation rate and the variation rate P′ with respect to time of the output P equivalent to liquid level. It can be seen from FIG. 9 that a favorable linear relationship exists between the liquid level variation rate and the variation rate P′ with respect to time of the output P equivalent to liquid level in the region where the liquid level variation rate is set to 150 mm/h or less. This reveals that the liquid level variation rate and the liquid level variation rate p′ with respect to time favorably correlate with each other. While a favorable linear relationship is represented in the region where the liquid level variation rate is set to 150 mm/h or less, it is possible to obtain a favorable linear relationship in the region where the liquid level variation rate is set up to 200 mm/h.

Therefore, it is possible to obtain leakage or liquid in the tank as a magnitude of the variation rate p′ with respect to time of the liquid level p measured by the pressure sensor 137.

The above second leakage detection can cover wider range. of liquid level variation rate than the first leakage detection does. On the other hand, that first leakage detection can measure a minute liquid level variation rate region with higher accuracy than the second leakage detection does.

As described above, a liquid level variation in the tank 1 occurs also when liquid is replenished into the tank through the liquid inlet 6 or when liquid is supplied to the outside through the liquid supply port 7. However, the rising or sinking speed or rising or sinking rat, of liquid level in the tank 1 obtained in the above case is generally considerably larger than the liquid level variation rate with respect to time or liquid level variation speed obtained in the case where usual leakage occurs.

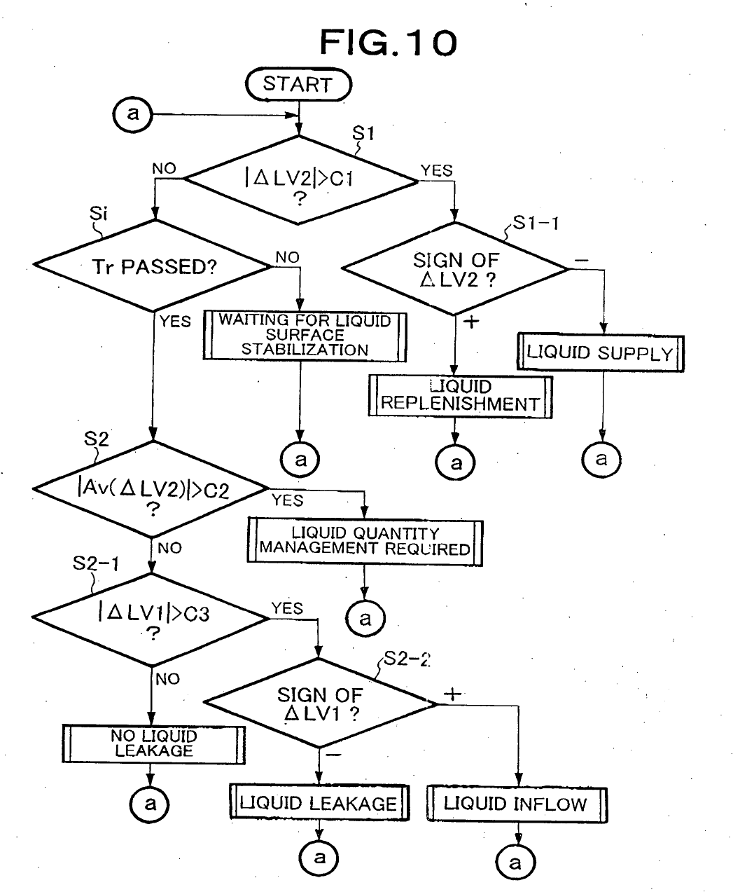

Thus, in the present embodiment, the liquid quantity variation detection including leakage detection and the output of the result thereof are processed as follows. FIG. 10 is a view showing the flow of the detection of quantity variation of a liquid in the tank and the output of the result thereof in the present embodiment.

First, in a first step (S1), it is determined whether the absolute value |ΔLV2| of liquid quantity variation Δ LV2 (corresponding to the time variation rate p′ of the liquid level) which is obtained in the second leakage detection exceeds a first predetermined value C1 or not. The first predetermined value C1 can be, for example, about 100 to 200 mm/h in terms of the time variation rate of liquid level. Herein, when it is determined that the absolute value |ΔLV2| of liquid quantity variation exceeds the first predetermined value C1, the sign of the liquid quantity variation ΔLV2 is discriminated in a first-first step (S1-1: this step is a part of the first step in the present invention). Herein, when the sign of ΔLV2 is minus, it is judged that there is liquid supply, and when the sign of ΔLV2 is plus, it is judged that there is liquid replenishment, outputting the result of the judgment together with the liquid quantity variation ΔLV2. The content of this output can be displayed on a display unit (not shown) connected to a CPU 68. Then, the operation returns to the first step S1.

On the contrary, when it is determined in the first step S1 that the absolute value |ΔLV2| of liquid quantity variation does not exceed the first predetermined value C1, then in an intermediate step (Si), it is determined whether a predetermined period of time Tr has passed or not since it was finally determined in the first step S1 that the absolute value |ΔLV2| of liquid quantity variation exceeds the first predetermined value C1. The predetermined period of time Tr is preferably a period of time which is a little bit longer than the stabilizing time of the liquid level LS after the liquid introduction from the outside into the tank or the liquid supply from the tank to the outside, and can be, for example, 10 to 60 minutes. Herein, when it is determined that the predetermined period of time Tr has not passed, that is, during this predetermined period of tire, a signal indicating that liquid surface stabilization is being waited for (stand-by) is output. The content of this output can be displayed on the display unit. The leakage detection control section can stop the first leakage detection during this predetermined period of time. During this predetermined period of time, the operation of the flow rate sensor section, more specifically, that of the voltage generating circuit 67 and the leakage detecting circuit 71 can be stopped, thereby allowing the power consumption to be reduced. Then, the operation returns to the first step S1. Further, when it is determined in the first step S1 that the absolute value ΔLV2| of liquid quantity variation exceeds the first predetermined value C1 (that is, when liquid replenishment or liquid supply is detected), stand-by for liquid surface stabilization is stopped. On the contrary, when it is determined in the intermediate step Si that the predetermined period of time Tr has passed, the operation proceeds to a second step (S2).

In the second step S2, there is obtained an average absolute value |Av(ΔLV2)| of liquid quantity variation as absolute value of an average value Av(ΔLV2) of liquid quantity variation ΔLV2 obtained by plural times of, for example, 20 to 300 times of the second leakage detections. That is, in this step, first, the result of the detections is stored in a memory till the results of the predetermined plural times of the second liquid quantity detections are obtained. This takes a period of time (for example, two to ten minutes) equal to a product of the second cycle and the plural times. Then, it is determined whether the obtained average absolute value |Av(ΔLV2)| of liquid quantity variation exceeds a second predetermined value C2 which is smaller that the first predetermined value C1. The second predetermined value C2 can be, for example, about 10 to 20 mm/h in terms of a liquid level variation speed. Herein, when it is determined that the average absolute value |Av(ΔLV2)| of liquid quantity variation exceeds the second predetermined value C2, the average value Av(ΔLV2) of liquid quantity variation relating to the average absolute value 51 Av(ΔLV2)| of liquid quantity variation is output as liquid quantity variation since this liquid quantity variation amounts to a quantity which cannot be ignored from a viewpoint of liquid quantity management in the tank, it is determined that liquid quantity management will be required due to liquid leakage or liquid inflow, outputting the result of the judgment together with the liquid quantity variation. The content of this output can be displayed on the display unit (not shown) connected to the CPU 68. Then, the operation returns to the first step S1. Further, when it is determined in the first step S1 that the average absolute value |ΔLV2| of liquid quantity variation exceeds the first predetermined value C1 (that is, when liquid replenishment or liquid supply is detected), required liquid quantity management is stopped. On the contrary, when it is determined in the second step (S2) that the average absolute value |Av(ΔLV2)| of liquid quantity variatior does not exceed the second predetermined value C2, the operation proceeds to a second-first step (S2-1: this step is e part of the second step in the present invention).

In the second-first step S2-1, it is determined whether or not the absolute value |ΔLV1| of liquid quantity variation ΔLV1 obtained in the first leakage detection exceeds a third predetermined value C3 which is smaller than the second predetermined value C2. The third predetermined value C3 can be, for example, about 0.01 to 0.03 mm/h in terms of a liquid level variation speed. Herein, when it is determined that the absolute value |ΔLV1| of liquid quantity variation does not exceed the third predetermined value C3, it is judged that the obtained liquid quantity variation falls within a tolerance range of errors of measurement and that there is substantially no liquid quantity variation (no liquid leakage), outputting the result of the judgment in place of or together with the liquid quantity variation. The content of this output can be displayed on the display unit (not shown) connected to the CPU 68. Then, the operation returns to thee first step S1. On the contrary, when it is determined in the second-first step S2-1 that the absolute value |ΔLV1| of liquid quantity variation exceeds the third predetermined value C3, the operation proceeds to a second-second step (S2-2: this step is a part of the second step in the present invention).

In the second-second step S2-2, the sign of liquid quantity variation ΔLV1 is discriminated. Herein, when the sign of ΔLV1 is minus, it is judged that there is liquid leakage, and when the sign of ΔLV1 is plus, it is judged that there is liquid inflow, outputting the result of the judgment in place of or together with the liquid quantity variation ΔLV1. The content of this output can be displayed on a display unit (not shown) connected to the CPU 68. Then, the operation returns to the first step S1.

The liquid level variation speed or time variation rate of liquid level (liquid level variation rate) correlates with a liquid quantity variation such as a leakage amount (leakage amount per unit time). That is, a value obtained by multiplying the liquid level variation speed or liquid level variation rate by the horizontal sectional area inside the tank obtained at a height position corresponding to the liquid level corresponds to the liquid quantity variation such as leakage amount of liquid. Therefore, it is possible to obtain the liquid quantity variation such as an amount of leakage of liquid in the tank based on the liquid level and liquid quantity variation such as leakage (liquid level variation speed or liquid level variation rate) detected as described above by previously storing the shape or size (i.e., relationship between the height position and horizontal sectional area inside the tank) in the memory 70 and referring to the stored data in the memory 70.

In the case where the tank has a vertically elongated cylindrical shape as shown in FIG. 1, i.e., the horizontal sectional area inside the tank is constant irrespective of the vertical position, a simple proportional relationship is established between the liquid level variation speed or liquid level variation rate and the liquid quantity variation such as leakage amount. Therefore, it is possible to easily calculate the liquid quantity variation such as leakage amount by multiplying the liquid level variation speed or liquid level variation rate by a proportional constant corresponding to the horizontal sectional area inside the tank without relation to the liquid level value itself. That is in this case, liquid quantity variation such as leakage detested by the apparatus of the present invention is substantially equal to a value obtained based on the liquid quantity variation such as leakage amount.

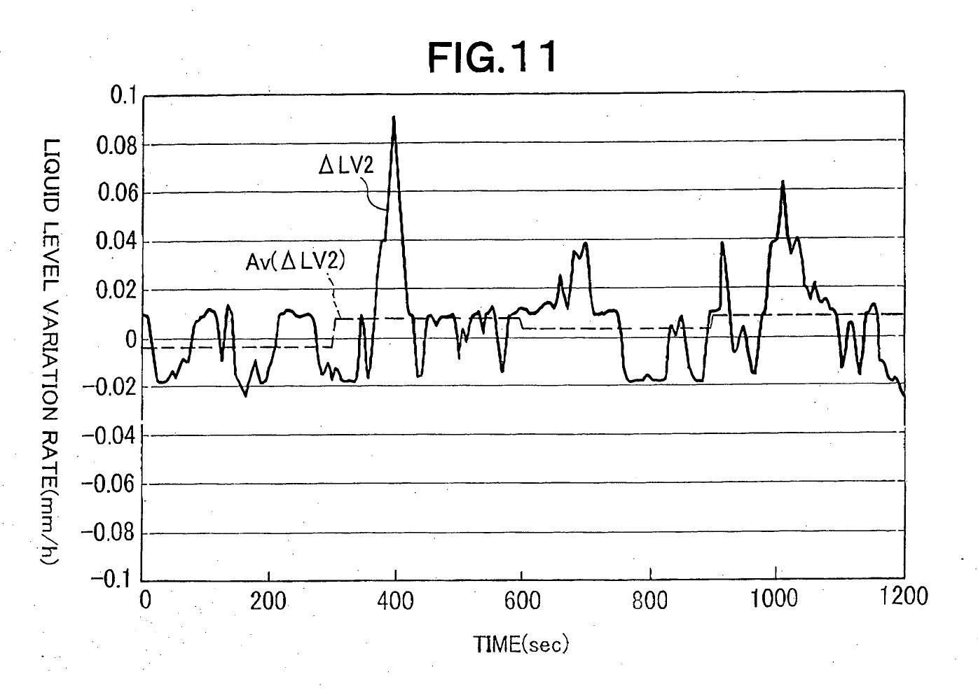

In FIG. 11, there is shown an example of a relationship between the liquid quantity variation ΔLV2 obtained in the second leakage detection and the average value Av(ΔLV2) of the liquid quantity variation ΔLV2 obtained in the plural times of the second leakage detections in the second step. Herein, the results of the detections under a condition of no liquid quantity variation in the tank are shown, and the liquid quantity variation are expressed in a corresponding liquid level variation speed. The liquid quantity variation ΔLV2 is obtained every five seconds, and the average value Av(ΔLV2) of liquid quantity variation is obtained every five minutes. Assuming that the third predetermined value C3 is 0.02 mm/h in terms of a liquid level variation speed, in case of the liquid quantity variation ΔLV2, there often appear for a relatively short time a measured value lying outs de a liquid level variation speed range in which it is judged that there is no leakage. As causes thereof, there can he conceived influence of electromagnetic waves coming into the detection apparatus via an output line on electric or electronic circuits, or liquid level variation due to temporal mechanical and external forces applied to the tank. On the contrary, in case of the average value Av(ΔLV2) of the liquid level variation which is averaged over a relatively long period of time, there appear no measured value lying outside a liquid level variation-speed range in which it is judged that there is no leakage. As described above, the present invention allows detections reflecting the actual situations accurately to be performed.

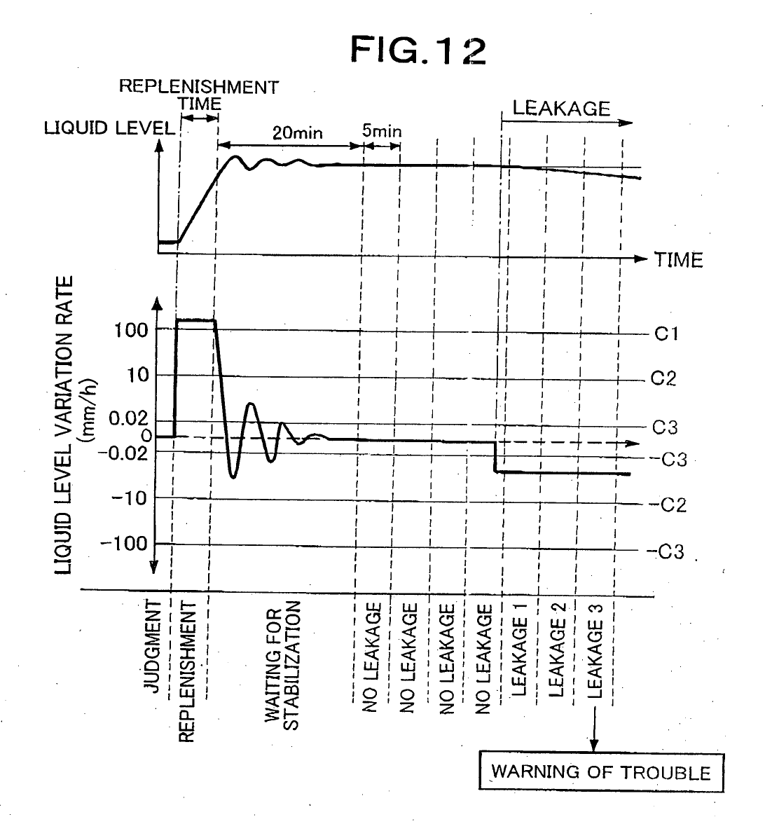

FIG. 12 is a view showing the variations of the liquid level and liquid level variation speed in the case where the liquid quantity in the tank varies due to various causes, and further showing the contents of the results of the judgments which are output from the CPU 68 corresponding to these situations respectively. In the second step after introducing liquid into the tank and waiting for liquid surface stabilization, a judgment is indicated every five minutes. As shown in the figure, it is judged that there is a trouble, if liquid leakage (or liquid inflow) has occurred three times in series, and as a result thereof a warning can be sent.

In the above-described embodiment, since the first leakage detection (first liquid quantity variation detection) is performed by using an integrated value δ(S₀-S)dt obtained by performing an integration over a period of time t3, a so-called averaged liquid quantity variation is obtained. Therefore, it is advantageous for reducing erroneous detections.

In the above-described embodiment, a pulse voltage generating circuit is used as the voltage generating circuit 67. However, in the present invention, there may be used as the voltage generating circuit 67 a constant voltage generating circuit which applies a constant voltage (that is, a constant direct current voltage) to the heater 135. Now, such an embodiment will be described.

In the present embodiment, a constant direct current voltage Q is applied from the constant voltage generating circuit used as the voltage generating circuit 67 in FIG. 5 to a thin-film heating element 182 of the heater 135. The heater maintains thereby a constant heating state. A part of the hear is transferred to the liquid in the measuring slim-tube 13b via a heat transfer member 181 and is used as heat source for heating the liquid.

When no liquid flows in the measuring slim-tube 13b, that is, when the flow rate of the liquid in the measuring slim-tube 13b is equal to zero, the detected temperatures of the first and second temperature sensors 133 and 134 are substantially identical if contribution of the heat transfer due to convection is ignored. However, when liquid flows in the measuring slim-tube 13b, the influence of heating the liquid by the heater 135 is exerted stronger on the downstream side than on the upstream side. Therefore, the detected temperatures of the first and second temperature sensors 133 and 134 are different from each other. Since a voltage output which is equivalent to the difference between the detected temperatures of the first and second temperature sensors 133 and 134 corresponds to a fluid flow rate, it is used as flow rate value output. That is, potentials at points a and b of a bridge circuit of the leakage detecting circuit 71 are input to a differential amplifying circuit 65. By setting the resistance values of resistors 62 and 63 of the bridge circuit suitably in advance, a voltage output S which is equivalent to the difference of the detected temperatures of the first and second temperature sensors 133 and 134 can be obtained from the differential amplifying circuit.

In the manner as described above, a flow rate measurement by detecting temperature difference between two fixed points is performed. In the flow rate measurement by detecting temperature difference between two fixes points according to the present invention, a value equivalent to the flow rate is obtained based on a temperature difference (actually, a difference in electrical characteristic, detected corresponding to the detected temperature difference) detected by the first and second temperature sensors disposed on the upstream and downstream sides of the heater respectively.

Now, operation of liquid quantity variation detection (including leakage detection) in the present embodiment, i.e., operation of the CPU 68 will be described. The operation of the CPU 68 in the present embodiment is the same as that in the embodiment described with reference to FIGS. 1 to 12 above except for the operation of the first leakage detection.

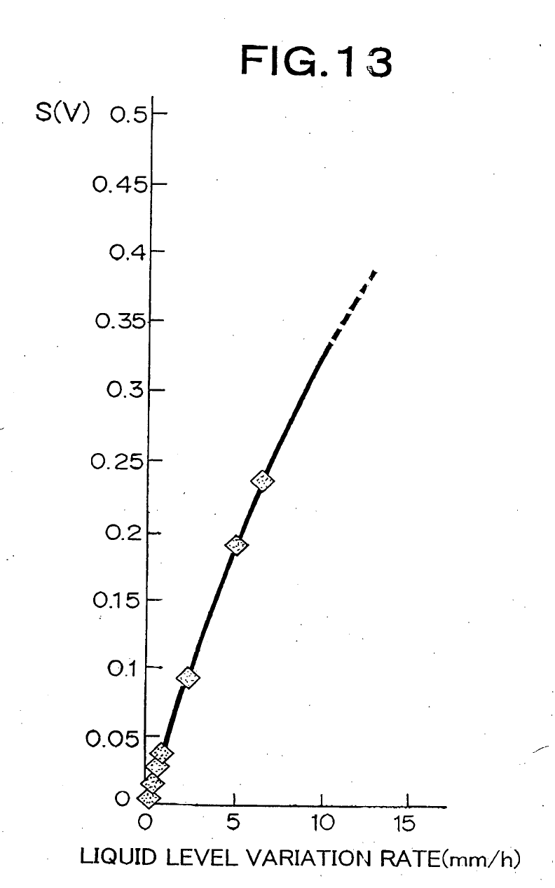

That is, the CPU 68 uses a stored calibration curve to convert the voltage output S into a corresponding flow rate value. FIG. 13 is a view showing an example of the calibration curve for the conversion of S. As shown in FIG. 13, a favorable linear relationship exists between the liquid level variation speed and voltage output S in the region where the liquid level variation speed corresponding to a flow rate value is set to less than, for example, 10 mm/h. Therefore, the same processing as that performed in the embodiment described with reference to FIGS. 1 to 12 can be performed for leakage in the CPU 68.

The voltage output S can be taken out at arbitrary timings. However, in view of reducing erroneous detections, it is advantageous to output a liquid quantity variation which is averaged over a period of time required for performing plural times of the second liquid quantity variation detections obtaining an average value Av(ΔLV2) of liquid quantity variation in the second step.

The present embodiment has an advantage that a calculation performed by the CPU 68 for obtaining the flow rate corresponding value in the first leakage detection becomes easier than the calculation performed in the embodiment described with reference to FIGS. 1 to 12.

What is claimed is:

1. An apparatus for detecting leakage of a liquid in a tank, comprising:
a measuring slim-tube into/from which the liquid in the tank is introduced or discharged through the lower end thereof;
a measuring tube connected to the upper end of the measuring slim-tube and having a sectional area larger than that of the measuring slim-tube;
a flow rate sensor section that is additionally provided to the measuring slim-tube and measures the flow rate of the liquid in the measuring slim-tube;
a pressure sensor for measuring the level of the liquid; and
a leakage detection control section connected to the flow rate sensor section and the pressure sensor,
wherein the leakage detection control section performs a first liquid quantity variation detection for detecting in a first cycle a liquid quantity variation in the tank based on a flow rate corresponding value which corresponds to the flow rate of the liquid calculated by using the outputs of the flow rate sensor section and a second liquid quantity variation detection for detecting in a second cycle a liquid quantity variation in the tank based on a time variation rate of a liquid level that is measured by the pressure sensor, and determines in a first step whether an absolute value of the liquid quantity variation obtained by the second liquid quantity variation detection exceeds a first predetermined value or not,
wherein when it is determined that the absolute value of liquid quantity variation does not exceed the first predetermined value, the leakage detection control section obtains in a second step an average absolute value as absolute value of an average value of liquid quantity variations of the liquid obtained by the second liquid quantity variation detection of plural times, and determines whether the average absolute value exceeds a second predetermined value smaller than the first-predetermined value, and
wherein when it is determined that the average absolute value exceeds the second predetermined value, the leakage detection control section outputs the average value of the liquid quantity variations relating to the average absolute value as a liquid quantity variation, and on the contrary, when it is determined that the average absolute value does not exceed the second predetermined value, the leakage detection control section outputs the liquid quantity-variation obtained by the first liquid quantity variation detection.

2. The apparatus for detecting leakage of a liquid in a tank as claimed in claim 1, wherein when the absolute value of the liquid quantity variation obtained by the first liquid quantity variation detection does not exceed a third predetermined value smaller than the second predetermined value, the leakage detection control section judges that there is no variation of the liquid quantity and outputs the result of such judgment in place of or together with the liquid quantity variation.

3. The apparatus for detecting leakage of a liquid in a tank as claimed in claim 1, wherein when it is determined that the average absolute value does not exceed the second predetermined value, and when the sign of the liquid quantity variation obtained by the first liquid quantity variation detection is minus on the one hand, the leakage detection control section judges that there is leakage of liquid, and when the sign is plus on the other hand, the section judges that there is inflow of liquid, outputting the result of such judgment in place of or together with the liquid quantity variation.

4. The apparatus for detecting leakage of a liquid in a tank as claimed in claim 1, wherein when it is determined that the average absolute value exceeds the second predetermined value, the leakage detection control section judges that liquid quantity management is required due to leakage or inflow of liquid, outputting the result of such judgment together with the liquid quantity variation.

5. The apparatus for detecting leakage of a liquid in a tank as claimed in claim 1, wherein when it is determined in the first step that the absolute value of the liquid quantity variation exceeds the first predetermined value, the leakage detection control section judges that there is liquid replenishment from the outside into the tank or liquid supply from the tank to the outside, outputting the result of such judgment together with the liquid quantity variation.

6. The apparatus for detecting leakage of a liquid in a tank as claimed in claim 5, wherein when it is determined in the first step that the absolute value of the liquid quantity variation exceeds the first predetermined value, and when the sign of the liquid quantity variation obtained by the second liquid quantity variation detection is minus on the one hand, the leakage detection control section judges that there is the liquid supply, and when the sign is plus on the other hand, the section judges that there is the liquid replenishment, outputting the result of such judgment together with the liquid quantity variation.

7. The apparatus for detecting leakage of a liquid in a tank as claimed in claim 1, wherein the leakage detection control section proceeds to the second step after a predetermined period of time has passed since it was finally determined in the first step that the absolute value of the liquid quantity variation exceeds the first predetermined value, and outputs a signal indicating that liquid surface stabilization is being waited for during the predetermined period of time.

8. The apparatus for detecting leakage of a liquid in a tank as claimed in claim 7, wherein the leakage detection control section stops the first liquid quantity variation detection during the predetermined period of time.

9. The apparatus for detecting leakage of a liquid in a tank as claimed in claim 8, wherein the leakage detection control section stops the operation of the flow rate sensor section during the predetermined periods of time.

10. The apparatus for detecting leakage of a liquid in a tank as claimed in claim 1, wherein when it is determined that the average absolute value does not exceed the second predetermined value, the leakage detection control section outputs as the liquid quantity variation to be output an average liquid quantity variation in the first liquid quantity variation detection during a period of time required for the second liquid quantity variation detection of plural times obtaining the average value of the liquid quantity variations.

11. The apparatus for detecting leakage of a liquid in a tank as claimed in claim 1, wherein the flow rate sensor section includes a first temperature sensor, a heater and a second temperature sensor sequentially arranged along the measuring slim-tube, and the leakage detection control section has a voltage generating circuit for applying voltage to the heater and a leakage detecting circuit connected to the first and second temperature sensors and generating an output corresponding to a difference between temperatures detected by these temperature sensors.

12. The apparatus for detecting leakage of a liquid in a tank as claimed in claim 11, wherein each of the first and second temperature sensors has a heat transfer member brought into contact with the outer surface of the measuring slim-tube and a temperature sensitive element coupled to the heat transfer member, and the heater has a heat transfer member brought into contact with the outer surface of the measuring slim-tube and a heating element coupled to the heat transfer member.

13. The apparatus for detecting leakage of a liquid in a tank as claimed in claim 11, wherein the voltage generating circuit is a pulse voltage generating circuit which applies a single pulse voltage to the heater, and the leakage detection control section calculates a flow rate corresponding value which corresponds to the flow rate of the liquid by integrating a difference between an output of the leakage detecting circuit and its initial value in response to the application of the single pulse voltage to the heater to thereby detect liquid quantity variation of the liquid in the tank based on the calculated value.

14. The apparatus for detecting leakage of a liquid in a tank as claimed in claim 13, wherein the single pulse voltage has a pulse width of 2 to 10 seconds, and the flow rate corresponding value is obtained by integrating the output of the leakage detecting circuit for 20 to 150 seconds.

15. The apparatus for detecting leakage of a liquid in a tank as claimed in claim 13, wherein the pulse voltage generating circuit applies the single pulse voltage to the heater at a time interval of 40 seconds to 5 minutes which is longer than the integration time period during which the difference between the output of the leakage detecting circuit and its initial value is integrated.

16. The apparatus for detecting leakage of a liquid in a tank as claimed in claim 11, wherein the voltage generating circuit is a constant voltage generating circuit which applies a constant voltage to the heater.

17. The apparatus for detecting leakage of a liquid in a tank as claimed in claim 1, wherein the pressure sensor is arranged in the vicinity of the lower end of the measuring slim-tube.
